(19) United States
(12) Patent Application Publication
(10) Pub. No.: US 2005/0284984 A1
(43) Pub. Date: Dec. 29, 2005

(54) Visual display provided with secured electronic architecture

(76) Inventors: Frederic De Lauzun, Saint Medard En Jalles (FR); Lilian Lacoste, Bordeaux (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/524,102

(22) PCT Filed: Aug. 11, 2003
(86) PCT No.: PCT/EP03/50371

§ 371 Date: Feb. 10, 2005

(30) Foreign Application Priority Data
Aug. 13, 2002 (FR) 02/10275

(51) Int. Cl. G01S 7/04

(52) U.S. Cl. 244/129.1; 342/175; 342/176

(57) ABSTRACT

The invention relates to a display device with a secured electronic architecture for aeronautical applications. Each device comprises an electronic computer and an associated matrix-type display device. The invention applies essentially to display systems having a small number of large-sized screens. The invention proposes to structure the display device as two independent display zones and the computer as two electronic subassemblies, which are also independent, in such a way that a failure of one of the elements entails, at most, only the failure of just one zone of the display device. The invention applies essentially to liquid-crystal active-matrix display devices having a lighting system based on fluorescent tubes. Two embodiments of the display zones are described. In the first embodiment, only one part of the area of the screen is lost in the event of a failure. In the second embodiment, the resolution of the display screen is simply downgraded by a factor of 2 in the event of a failure.

The field of the invention is that of electronic display devices used on aircraft, and more particularly that of safeguarding the electronic architectures of which they are composed.

In a modern aircraft cockpit, most information is presented to the pilots via systems comprising a number of electronic display devices. At the present time, the display devices are very often liquid-crystal matrix displays. Until recently, matrix display technology was not capable of producing, in a simple manner, for aeronautical applications, matrix displays having sizes exceeding 15 cm per side and of sufficient resolution. Owing to the large amount of useful flight and navigation information, several matrix-screen devices are then necessary in order to present all of this information. For example, cockpits of the Airbus A320/A330/A340 family have six main display screens, namely two central screens and four screens placed symmetrically in front of each pilot and copilot.

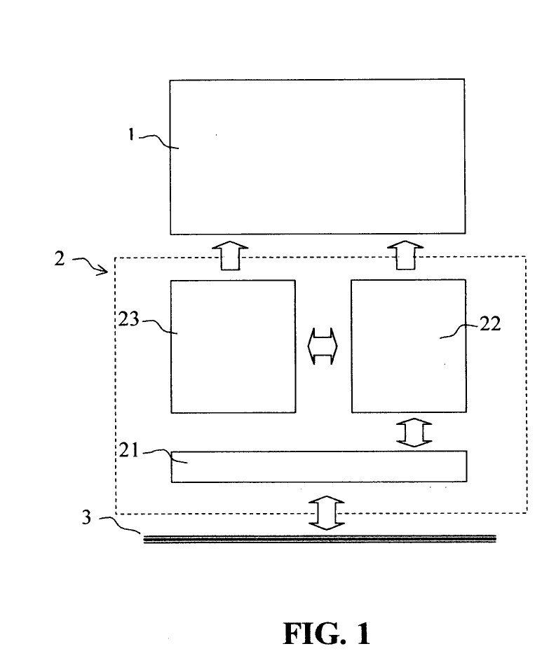

Conventionally, a display device comprises the subassemblies shown in FIG. 1. These are:
a display device 1;
an electronic computer 2 comprising the following subassemblies:
   an electronic interface unit 21,
   an electronic unit 22 for computing and generating images and
   an electrical supply unit 23.

The electronic interface unit 21 communicates with the aircraft bus 3 common to the various display devices and recovers the parameters needed for the display device. These parameters are processed by the electronic unit 22, which generates the image that is then displayed on the display device 1. An electrical supply unit 23 provides, from the on-board mains (not shown in FIG. 1), the various supplies needed for the computer and for the display device. The arrows in FIG. 1 indicate the directions of the links between the various elements. Single-headed arrows represent one-way control links, while the double-headed arrows represent control or two-way links.

In this type of architecture, a failure of one of the electronic subassemblies generally results in the loss of the display screen. Since the information presented is vital for the safety of the aircraft in-flight, it is demanded of the airframe manufacturers and of the equipment suppliers producing these systems to ensure that they are very reliable and have a high level of safeguarding. Safeguarding and reliability are partly provided by the redundancy of the electronic architectures. Thus, when the failure of a screen is detected, the critical information normally sent to this screen is generated and sent to the screens that are still functional. This system operates well as long as there is a sufficient number of display screens. Thus, on an Airbus of the A320/A330/A340 type, the loss of one of the six screens entails the loss of only 17% of the total display area and each pilot or copilot still has at least one functional screen in his central field of view.

Technological progress now allows matrix screens of larger size to be produced, while still maintaining high-resolution images. Currently, the diagonal of this type of screen may be up to, or even exceed, 25 centimeters and the resolution may exceed 120 DPI (dots per inch). Thus, a display system may be produced that comprises no more than a maximum of four display devices, all maintaining the same amount of information displayed and with equivalent image quality. The system of display devices thus becomes simpler and less expensive than a conventional system comprising a larger number of screens. However, in this case, the complete loss of a screen can no longer be compensated for by the simple redundancy of the display units, the display area lost being too large. The loss of a screen then becomes a critical event liable to prevent either the flight, if the failure occurs before takeoff, or the normal continuation of the flight, if the failure occurs during the flight. At the present time, this problem is of sufficient importance to constitute a serious obstacle to the certification of systems comprising a small number of large screens.

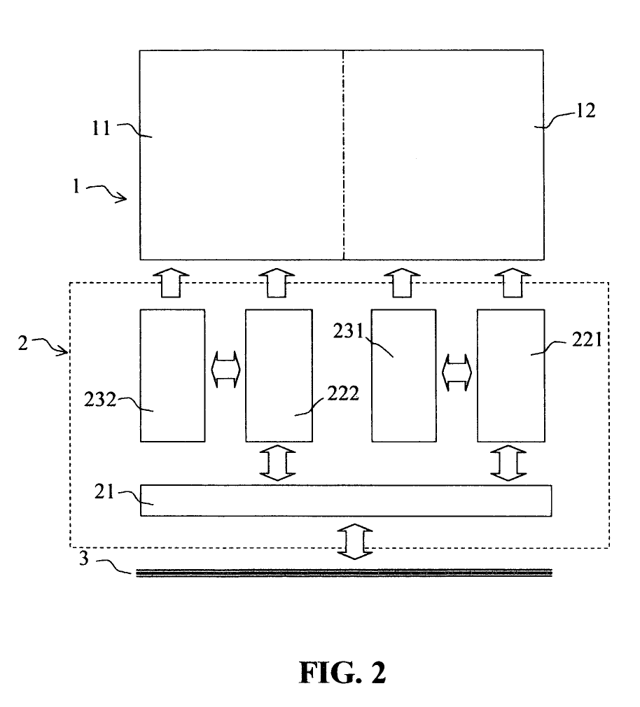

To solve this problem, the invention proposes, on the one hand, to structure the electronic architecture of each display device as two independent electronic subassemblies and, on the other hand, to structure the display zone as two independent zones in such a way that the loss of any one of the various electronic subassemblies or of one of the two display zones entails at most the loss of a half of the display device. The diagram in FIG. 2 shows the general principle of the invention. A single display screen 1 is structured as two independent zones 11 and 12, each of the zones 11 or 12 being controlled by a subunit 221 or 222 for computing and generating images which is dedicated thereto. This subunit is supplied via its own electrical supply unit 231 or 232. The interface unit 21 is common to the two subunits 221 or 222 for computing and generating images. The matrix structure of the display device permits it to be structured as two independent zones.

This type of device makes it possible to ensure the required reliability and safeguarding, at the expense of a marginal increase in cost. This is because there remains just a single display screen. Moreover, the computing unit is often built around two computing subunits so as to be able to generate the image at a sufficiently high refresh rate, of the order of 20 ms. Consequently, the splitting of the electronic unit into two independent subassemblies entails only minor modifications.

More precisely, the subject of the invention is a display device, for aeronautical applications, which comprises an electronic computer controlling a display device, said display device being organized as a matrix of N rows of M columns of dots, said computer comprising essentially an electronic first assembly for interfacing with the outside, an electronic second assembly for computing and generating images and a third assembly for electrical supply, the display device being structured as two independent display zones, the electronic second assembly for computing and generating images being structured as two independent electronic subassemblies, the supply third assembly also being structured as two independent electronic subassemblies in such a way that the failure of any one of these various subassemblies entails, at most, the loss of only one of the two display zones.

The method may apply to monochrome displays containing a single type of dot. However, most current displays are color displays. In this case, the dots are organized as identical triplets called pixels, each pixel comprising three dots, each emitting within a different spectral band.

The method may apply to all types of matrix displays such as, for example, electroluminescent displays, organic light-emitting diode displays (OLEDs) or plasma screens. However, the optical performance requirements, the reliability constraints and the behavior in aeronautical environments mean that at the present time it is preferred to use active-matrix liquid-crystal displays or AMLCDs for the display devices of instrument panels. In this case, the display device is composed of a liquid-crystal active matrix and of a lighting unit composed of aligned fluorescent tubes, said active matrix essentially comprising:
a first polarizer called the analyzer;
a first glass plate that includes at least one transparent counter-electrode;
a liquid-crystal layer, generally of the nematic type;
a second glass plate having a matrix of control rows and control columns, a switch controlling an elementary electrode being at each intersection of a row with a column;
a second polarizer;
a first electronic driving assembly located around the periphery of the matrix addressing the control rows; and
a second electronic driving assembly located around the periphery of the matrix addressing the control columns,
   each assembly consisting of the elementary electrode, of parts of the liquid-crystal layer and of the transparent counter-electrode (51) that are located above said elementary electrode (64) constituting a dot, the light transmission of each dot depending on the voltages for addressing the control row and the control column of the elementary electrode of said dot. In the case of a color matrix display, the transparent counter-electrode of the first glass plate of the active matrix display comprises a regular tiling of three types of color filter, each elementary electrode being placed beneath a color filter, each assembly consisting of an elementary electrode, of the associated color filter, of parts of the liquid-crystal layer and of the transparent counter-electrode that are located above said elementary electrode constituting a color dot, each pixel consisting of three adjacent dots of different color.

In a first embodiment, the two display zones are geometrically separate, with no common overlap area. More precisely, for a display device of rectangular shape, the two display zones are also rectangles of identical shape, the area of each of said rectangles being equal to one half of the total area of the display device. For example, in the case of a rectangular screen in landscape mode, the two zones generally occupy the right-hand and left-hand portions of the display rectangle, respectively. In the event of a single failure, only one half of the display device is therefore lost, the second half remaining functional.

When the display device is based on liquid crystals, the independence of the two zones is ensured in the following manner:
the first glass plate of the active matrix has two independent counter-electrodes, the first corresponding to the first zone of the display device and the second corresponding to the second zone of said device;
the first electronic assembly for driving the rows of the active matrix comprises two independent subassemblies in such a way that the first subassembly controls the rows of the first zone and the second subassembly controls the rows of the second zone;
the fluorescent tubes are controlled by two independent electronic supply subassemblies, the first of said subassemblies supplying the lighting tubes located beneath the first zone of the display device, the second of said subassemblies supplying the lighting tubes located beneath the second zone of the display device.

In a variant, the first glass plate of the active matrix has a single counter-electrode supplied by the two independent supply subassemblies. The common voltage supply by means of two different supply sources does not impair the operation of this single electrode.

Advantageously, within the context of this first embodiment, in the event of failure of any one of the electronic subassemblies or of one of the two display zones causing the loss of one of the two display zones, the fluorescent tubes corresponding to the lost display zone are automatically turned off by the electronic subassembly corresponding to this lost zone. This is because the active matrices are transparent (Normally White State) when no voltage is applied to the matrix of rows and columns. This arrangement gives optimum contrasts and also makes it possible for the failed dots to be easily identified since they appear automatically white on the generally black background of the display devices. In the event of failure, especially a partial failure of the electrical supplies, the affected zone of the matrix may therefore be transparent. It is therefore essential for the fluorescent tubes located beneath this zone to be turned off so that the pilot perceives a failed zone as a dark area.

Advantageously, in the event of failure of any of the electronic subassemblies or of one of the two display zones causing the loss of one of the two display zones, the information necessary for flying, called the Primary Flight Display, is automatically displayed in the still functional display zone by an electronic reconfiguration unit present in the electronic subassembly for computing and generating images serving said display zone. This is because the information presented to the pilot does not have the same criticality. The Primary Flight Display information, which especially comprises the attitude, altitude, speed, heading and wind direction information, must in particular continue to be presented, including in the event of a partial failure. If the zone affected by a failure is dedicated to the presentation of the above information, then this will be generated on the still functional screen zone instead of less critical information such as, for example, three-dimensional scenery or cartographic images.

In a second embodiment, the active matrix comprises two independent subassemblies of dots, each of the two subassemblies being composed of columns of dots controlled by a control column subassembly, each column subassembly depending on an independent driving subassembly, the two control column subassemblies being interlaced, the control rows common to the two zones being driven on either side of the matrix by two independent driving subassemblies that are each controlled by one of the two different electronic subassemblies for computing and generating images, the two zones being lit by two rows of interlaced fluorescent tubes, each of the two rows being supplied by an independent electronic supply subassembly. In this case, the information remains present over the entire area of the display device, including in the event of a partial failure. However, the resolution of the display is reduced by a factor of two.

When the matrix display is a color matrix display, each color pixel is composed of three color dots, which very conventionally are green, red and blue. As the three dots are generally placed along a line, they are therefore controlled by three different columns. To interlace the columns, there are then three possible main options.

In a first variant, the control columns are interlaced one column in two. In this case, in the event of failure of one zone of the display, one control column in two will be affected.

In a second variant, the control columns are interlaced every two control columns.

Finally, in a third variant, the control columns are interlaced every three control columns. In the latter case, one pixel in two is affected by the failure.

Advantageously, the two driving subassemblies for driving the columns of the active matrix possess an electronic function such that, in the event of loss of one of the two subassemblies of dots making up the active matrix, the control columns for the subassembly of dots that is lost are addressed with a voltage such that the transmission of the dots of said lost subassembly is minimal.

As was mentioned, active matrix displays for aeronautical applications are generally “normally white”. In this case, a failure in one zone of the display may cause, by the absence of voltage on the columns, maximum transparency on the dots driven by these columns, therefore causing a great increase the luminance of the image presented and a reduction in its contrast. To avoid this problem, it is necessary to force the control voltage for the columns of the failed zone down to a value such that the transmission of the dots is minimal.

Advantageously, within the context of this second embodiment, the information displayed is composed of characters, the size and the thickness of the lines of which are sufficient so that, in the event of loss of one of the display zones, the information remains easily legible. This thickness must correspond to at least two pixels.

Advantageously, within the context of this second embodiment, in the event of loss of one of the two subassemblies of dots making up the active matrix, the luminance of the fluorescent tubes is automatically doubled. As was stated, it is advantageous to force the control voltage for the columns of the failed zone down to a value such that the transmission of the dots is minimal. In this case, the contrast of the displayed information is maintained. However, on average the displayed information is half as bright. To return to the initial luminance, it is then necessary to double the luminance of the fluorescent tubes.

Advantageously, in the event of loss of a row of lighting tubes, the luminance of the tubes of the still functioning row is automatically doubled. This arrangement makes it possible to maintain the same final luminance of the image. The various control signals for each row of lighting tubes are provided by an electronic control function specific to each electronic subassembly for calculating and generating images.

The invention will be more clearly understood and other advantages will become apparent on reading the description that follows, given by way of non-limiting example, and with the aid of the appended figures which comprise:

FIG. 1, which shows the basic principle of a display device according to the prior art;

FIG. 2, which shows the basic principle of a display device according to the invention;

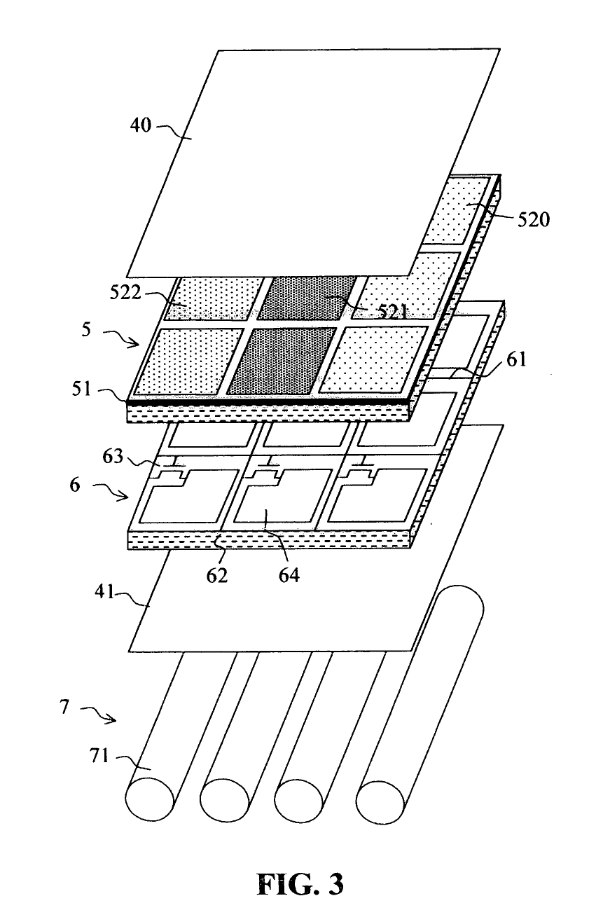

FIG. 3, which shows an exploded view of part of a color active-matrix display device according to the prior art, the liquid-crystal layer located between the two glass plates not being shown for the sake of clarity;

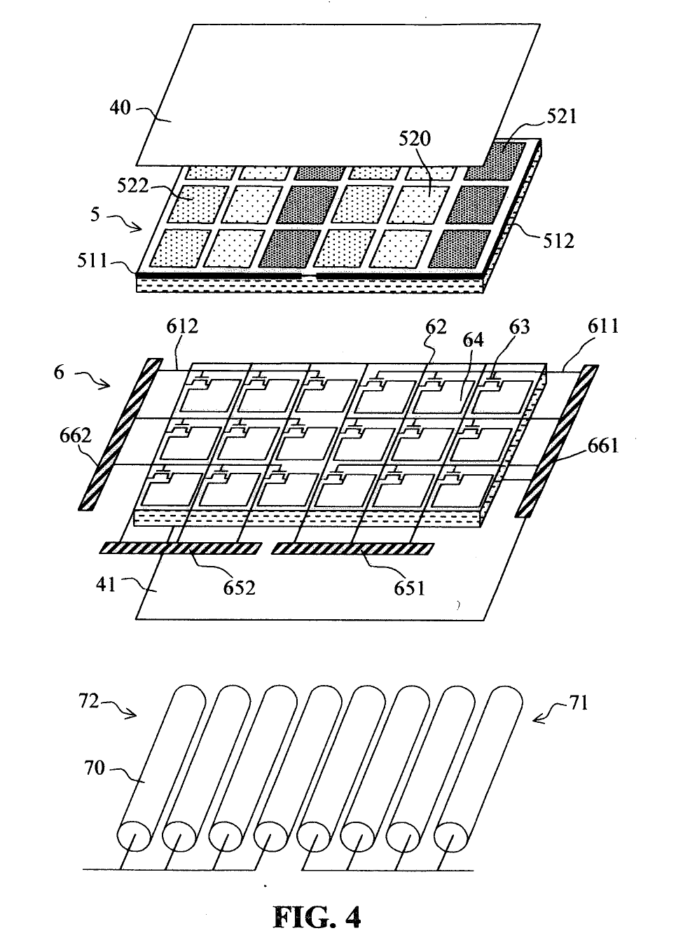

FIG. 4, which shows an exploded view of part of a color active-matrix device according to a first embodiment of the invention;

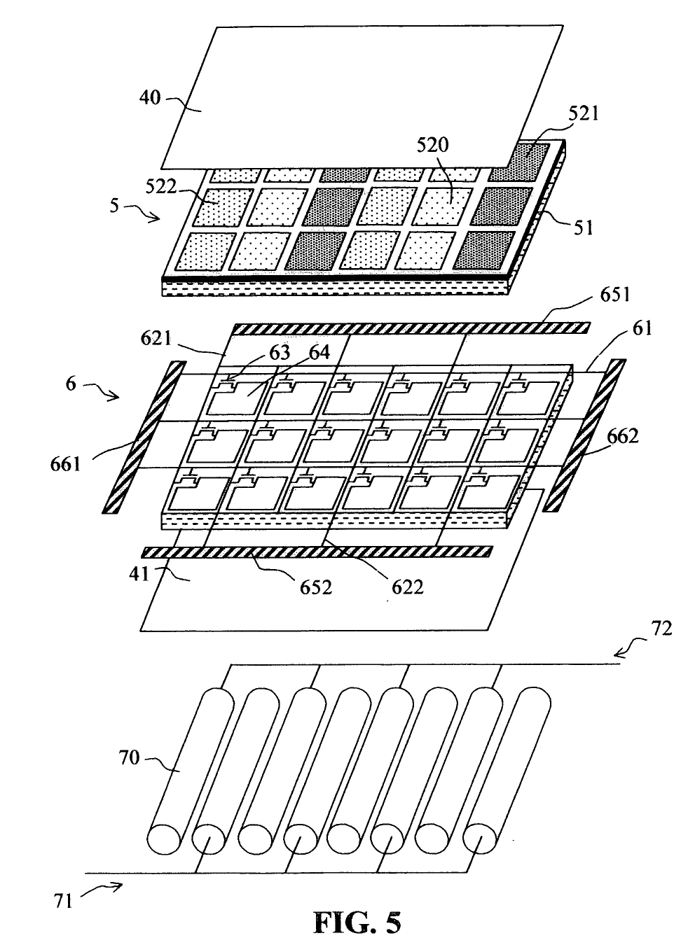

FIG. 5, which shows an exploded view of part of a color active-matrix device according to a second embodiment of the invention, the addressing of the control columns being represented in a first variant in this view;

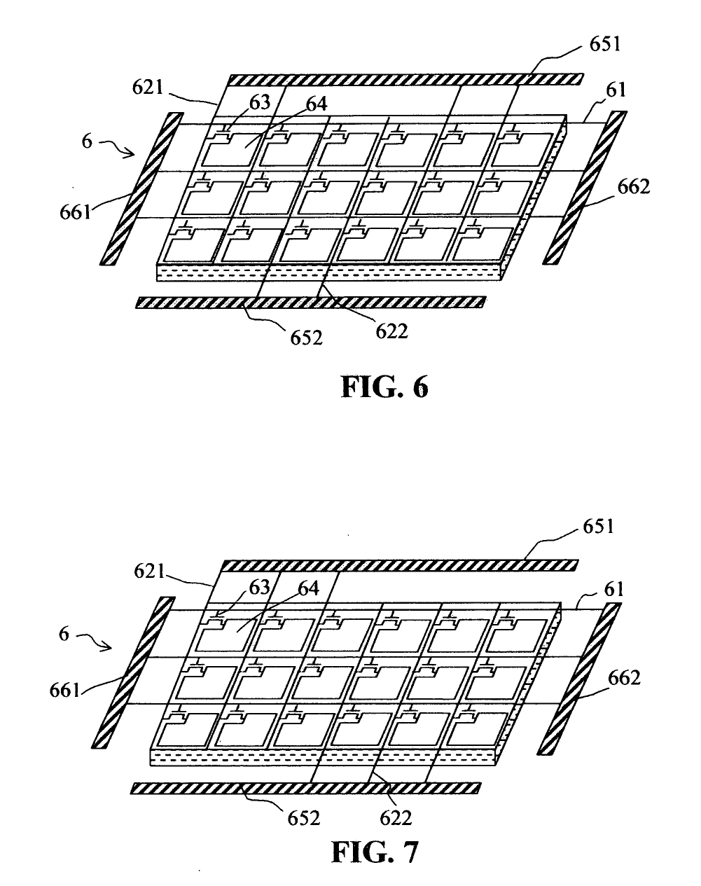

FIG. 6, which shows a second variant of the method of addressing the control columns; and

FIG. 7, which shows a third variant of the method of addressing the control columns.

FIG. 3 shows a simplified exploded view of part of a color active-matrix display device according to the prior art. Three rows and three columns are shown, which define in total nine dots. The device essentially comprises a liquid-crystal matrix and a lighting unit 7 consisting of fluorescent tubes 71. The matrix essentially comprises a first glass plate 5 and a second glass plate 6. The plates 5 and 6 are plane and parallel to each other. A liquid-crystal layer (not shown in the figure) is inserted in the space between these two plates 5 and 6. The combination of the two plates is placed between two linear polarizers 40 and 41. The plate 5 is located on the same side as the observer and the plate 6 is located on the same side as the lighting tubes.

The plate 5 includes a single transparent counter-electrode 51 and in the case of a color matrix a tiling of color filters 520, 521 and 522. Each filter corresponds to a color dot. Three adjacent different color dots correspond to a color pixel. The plate 6 includes an electronic circuit essentially composed of control lines 61 and control columns 62. An electronic switch 63 of the TFT (Thin Film Transistor) type is inserted at each intersection of a row with a column. This switch drives an elementary electrode 64. The set of control lines is driven by a first electronic driving assembly (not shown in the figure). The set of control columns is also driven by a second driving assembly.

The matrix acts as an optical valve. In the absence of a control voltage, the light coming from the fluorescent tubes 71, which is polarized by the linear polarizer 41, passes through the liquid-crystal layer. The direction of polarization of the light then undergoes a rotation through ninety degrees due to the natural birefringence of the liquid-crystal layer. The direction of polarization of the analyzer is oriented in such a way that the polarized light passes through it without attenuation. The matrix is then said to be “normally white”. When the liquid-crystal layer is subjected to a potential difference, its bifringence changes and consequently the direction of polarization of the light passing through the layer also changes. This variation in the polarization is transformed into a light intensity variation by the polarizer 40. For a given potential difference, a specified transmission is thus obtained.

Any color image can be represented in the form of a matrix of N rows of color pixels ordered in M columns. Each pixel can be decomposed, according to the conventional laws of trivariant color vision, in the form of three color dots. The color and the luminance of the pixel are obtained by combining the three luminous intensities of each dot.

The generation of a matrix image takes place in the following manner on an active matrix having the same distribution of pixels. The counter-electrode 51 is subjected to a constant electrical potential. To generate the various color rows of the image, each control row 61 of the matrix is addressed in succession with a certain voltage. This addressing may take place either on just one side of the row or on both its ends by two separate control signals. This voltage is sufficient to close all the switches 63 of the actuated row. The switches of the other rows remain open. Over the period during which said row is being addressed, all the control columns 62 are subjected to voltage levels representative of the transmission of the elementary dots of the corresponding row of the image. These voltage levels are applied only to the electrodes 64 of the control row actuated via the closed switches 63. Thus, one and only one row of dots, the luminous transmission of which corresponds to the corresponding row of the image, is generated. Next, the following row is actuated and, by scanning the matrix, row by row, the color image is thus created.

FIG. 4 shows a simplified exploded view of part of a color active-matrix display device according to a first embodiment of the invention. In the case of a monochrome matrix (not shown), the arrangements described will be identical, the color filters simply being eliminated and the dots then all being identical. In the embodiment shown in FIG. 4, the display device consists of a zone occupying the right-hand part of the display and a zone occupying the left-hand part of the display. Three rows and six columns are shown, which define in total eighteen dots. To make the two, right-hand and left-hand, display zones independent, the following provisions are made:
the counter-electrode 51 of the plate 5 is replaced with two independent counter-electrodes 511 and 512 supplied by two different supplies;
each control row 61 is replaced with two control rows 611 and 612, the first row 611 serving the right-hand part of the screen and the second row 612 serving the left-hand part of the screen. The set of rows 611 is driven by a first electronic driver 661 and the set of control rows 612 is driven by a second electronic driver 662. The two electronic drivers are independent and controlled by two different computer subassemblies;
the control columns serving the right-hand zone of the screen are driven by a first electronic driver 651 and the control columns serving the left-hand zone of the screen are driven by a second electronic driver 652; and
the lighting unit 7 is replaced with two independent lighting units 71 and 72 placed beneath the right-hand zone of the screen and beneath the left-hand zone of the screen, respectively.

Thus, with these arrangements, the screen is split into two completely independent zones in such a way that a failure, either of an electrical supply or of an electronic driver, or even of a lighting zone, can affect just one of the two display zones, the second zone remaining functional.

In a variant (not shown), the first glass plate of the active matrix includes a single counter-electrode supplied via the two independent supply subassemblies. Common voltage supply via two different supply sources must not impair the operation of this single electrode.

FIG. 5 shows a simplified exploded view of part of color active-matrix display device according to a second embodiment of the invention. In the case of a monochrome matrix (not shown), the provisions described will be identical, the color filters simply being omitted and the dots then all being identical. FIG. 5 shows a first variant of this second embodiment. In this second embodiment, the display device consists of two independent zones each consisting of interlaced columns 621 and 622 of dots. Three rows and six columns are shown, which define in total eighteen dots. In order for the two display zones to be independent, the following provisions are made:
the control columns 621 and 622 are driven by two independent electronic drivers 651 and 652. Each of the electronic drivers drives one column in two, as indicated in FIG. 5. Thus, for example, the first electronic driver drives the first, the third and, more generally, every odd column. The second electronic driver drives the second, fourth and, more generally, every even column;
the control rows 61 common to the two zones are driven, on each side of the matrix, by two driving subassemblies 661 and 662. These two electronic drivers are independent and controlled by two different computer subassemblies; and
the lighting unit 7 is replaced with two independent lighting units 71 and 72 composed of interlaced fluorescent tubes 70. Each of these two lighting units is supplied via an independent electrical supply.

Thus, with these provisions, the screen is split into two completely independent zones in such a way that the failure of one zone cannot affect the other zone.

FIGS. 6 and 7 shows two possible variants of this embodiment in the case of a color matrix. In these figures, only the plate 6 has been shown. These variants differ from each other by the way in which the columns 621 and 622 are addressed. In FIG. 6, each of the electronic drivers 651 and 652 drives the columns in twos. Thus, for example, the first electronic driver 651 drives the first and second columns, then the fifth and sixth columns. The second electronic driver 652 drives the third and fourth columns and then the seventh and eighth columns. In FIG. 7, each of the electronic drivers 651 and 652 drives the columns in threes. Thus, for example, the first electronic driver 651 drives the first, second and third columns while the second electronic driver 652 drives the fourth, fifth and sixth columns. These different variants make it possible, depending on the resolution of the display device and on the type of information to be displayed, to optimize the ergonomics of the device in degraded mode, while in particular minimizing the blind spots and the chromatic drifts of the pixels due to the absence of some of the dots.

In the event of failure, the control voltage for the columns of the failed zone is lowered to a value such that the transmission of the dots controlled by these columns is a minimum. In this case, the contrast of the displayed information is maintained. However, on average the display is half as bright.

To recover the initial luminance, it is then necessary to double the luminance of the fluorescent tubes. To extend their lifetime, the fluorescent tubes are generally underpowered in normal operating mode, and consequently they emit a luminous flux substantially less than the maximum possible flux. In the event of failure, the supply voltages for the fluorescent tubes are increased so as to recover this maximum flux. Thus, the mean luminance of the image is maintained. The degradation in the lifetime of the tubes that is brought about by this increased supply is a minor problem, in so far as the failure will necessarily have to be dealt with rapidly.

1. A display device, for aeronautical applications, comprising:
an electronic computer controlling a display device, said display device being organized as a matrix of N rows of M columns of dots, said computer comprising an electronic first assembly for interfacing with the outside, an electronic second assembly for computing and generating images and a third assembly for electrical supply, the display device being structured as two independent display zones the electronic second assembly for computing and generating images being structured as two independent electronic subassemblies, wherein the third, supply assembly is also structured as two independent electronic subassemblies in such a way that the failure of any one of these various subassemblies entails, at most, the loss of only one of the two display zones.

2. The display device as claimed in claim 1, wherein the display device is composed of a liquid-crystal active matrix and of a lighting unit composed of aligned fluorescent tubes, said active matrix essentially comprising:
a first polarizer;
a first glass plate (5) that includes at least one transparent counter-electrode;
a liquid-crystal layer;
a second glass plate having a matrix of control rows and control columns, a switch controlling an elementary electrode being at each intersection of a row with a column;
a second polarizer;
a first electronic driving assembly located around the periphery of the matrix addressing the control rows; and
a second electronic driving assembly located around the periphery of the matrix addressing the control columns,
each assembly having of the elementary electrode, of parts of the liquid-crystal layer and of the transparent counter-electrode that are located above said elementary electrode constituting a dot, the light transmission of each dot depending on the voltages for addressing the control row and the control column of the elementary electrode of said dot.

3. The display device as claimed in claim 1, wherein the two display zones are geometrically separate, with no common overlap area.

4. The display device as claimed in claim 3, wherein, for a display device of rectangular shape, the two display zones are also rectangles of identical shape, the area of each of said rectangles being equal to one half of the total area of the display device.

5. The display device as claimed in claim 2, wherein:
the first electronic assembly for driving the rows of the active matrix comprises two independent subassemblies in such a way that the first subassembly controls the rows of the first zone and the second subassembly controls the rows of the second zone;
the fluorescent tubes are controlled by two electronic supply subassemblies each dependent on one of the two electronic supply subassemblies, the first of said subassemblies supplying the lighting tubes located beneath the first zone of the display device, the second of said subassemblies supplying the lighting tubes located beneath the second zone of the display device.

6. The display device as claimed in claim 5, wherein the first glass plate of the active matrix has two independent counter-electrodes, the first corresponding to the first zone of the display device and the second corresponding to the second zone of said device, said counter-electrodes being each supplied by the two independent supply subassemblies.

7. The display device as claimed in claim 6, wherein the first glass plate of the active matrix has a single counter-electrode supplied by the two independent supply subassemblies.

8. The display device as claimed in claim 5, wherein each of the two electronic subassemblies possesses an electronic cutoff function allowing the supply for the electronic supply subassemblies for the fluorescent tubes to be cut off; in the event of a failure of any one of the electronic subassemblies or of one of the two display zones, causing the loss of one of said display zones, said electronic cutoff function of the electronic subassembly corresponding to said display zone that has failed is activated in such a way that the fluorescent tubes corresponding to this same, lost display zone are automatically switched off.

9. The display device as claimed in claim 5, wherein each of the two electronic subassemblies possesses an electronic reconfiguration function making it possible to generate only the information essential for flying, in a format corresponding to one screen half, in such a way that, in the event of failure of any one of the electronic subassemblies or of one of the two display zones causing the loss of one of the two display zones, the electronic reconfiguration function of the electronic subassembly corresponding to the display zone that is still functional is activated.

10. The display device as claimed in claim 2, wherein the active matrix comprises two independent subassemblies of dots, each of the two subassemblies being composed of columns of dots controlled by a control column subassembly:
each column subassembly depending on an independent driving subassembly, each controlled by one of the two different electronic subassemblies for computing and generating images, the two control column subassemblies being interlaced;
the control rows common to the two zones being driven on either side of the matrix by two independent driving subassemblies that are each controlled by one of the two different electronic subassemblies for computing and generating images; and
the two zones being lit by two rows of interlaced fluorescent tubes, each of the two rows being supplied by an independent electronic supply subassembly.

11. The display device as claimed in claim 10, wherein the control columns are interlaced one column in two.

12. The display device as claimed in claim 10, wherein the control columns are interlaced every two control columns.

13. The display device as claimed in claim 10, wherein the control columns are interlaced every three control columns.

14. The display device as claimed in claim 10, wherein the two driving subassemblies for driving the columns of the active matrix possess an electronic function such that, in the event of loss of one of the two subassemblies of dots making up the active matrix, the control columns for the subassembly of dots that is lost are addressed with a voltage such that the transmission of the dots of said lost subassembly is minimal.

15. The display device as claimed in claim 10, wherein the information displayed is composed of characters, the size and the thickness of the lines of which are sufficient so that, in the event of loss of one of the display zones, the information remains easily legible.

16. The display device as claimed in claim 10, wherein each of the two electronic subassemblies possesses an electronic control function for controlling the supply of the electronic supply subassemblies for the fluorescent tubes; in the event of loss of one of the two subassemblies of dots making up the active matrix, the two electronic control functions are activated so that the luminance of the fluorescent tubes is automatically doubled.

17. The display device as claimed in claim 10, wherein, in the event of loss of one row of lighting tubes, the luminance of the tubes of the row still operating is automatically doubled by the corresponding electronic control function.
